(19) United States
(12) Patent Application Publication
(10) Pub. No.: US 2003/0046354 A1
(43) Pub. Date: Mar. 6, 2003

(54) Electronic mail confirmation system and electronic mail system, communication terminal, internet connection device and electronic mail server device for using the same electronic mail confirmation system

(76) Inventor: Takayuki Mizuno, Yamatokoriyama-shi (JP)

Correspondence Address: BIRCH STEWART KOLASCH & BIRCH, PO BOX 747, FALLS CHURCH, VA, 22040-0747, US

(21) Appl. No.: 10/228,197

(22) Filed: Aug. 27, 2002

(30) Foreign Application Priority Data
Sep. 4, 2001 (JP) 2001-266611

(51) Int. Cl. G06F 15/16

(52) U.S. Cl. 709/206

(57) ABSTRACT

An electronic mail confirming system enabling a user to confirm the existence of newly-arrived and unopened emails with no charge for communication through a public telecommunication network is realized. A user's communication terminal, e.g., an internet facsimile apparatus sends an inquiry call by dialing a connection through a public telecommunication network to a specified telephone number of an internet connection device that in turn identifies the calling user by a caller telephone number notified by the public telecommunication network and immediately disconnects the call connection. The internet connection device uses different calling numbers for informing of the existence of emails and the absence of emails and sends a response call by dialing a connection to the user's communication terminal that in turn confirms the existence or absence of emails by caller information provided by the public telecommunication network and immediately disconnects the call connection.

### BACKGROUND OF THE INVENTION

The present invention relates to an electronic mail confirmation system and an electronic mail system using the same electronic mail confirmation system as well as a communication terminal, an internet connection device and an electronic mail server device, all of which are capable of using the same electronic mail confirmation system. Specifically, this invention relates to an electronic mail confirmation system that enables a user's communication terminal for receiving and transmitting information in electronic form over a public telecommunication network to inquire and confirm whether a newly-arrived email or an unopened email exists in an internet connection device or an server device maintained by an ISP (Internet Service Provider) as well as an electronic mail system, a communication terminal, an internet connection device and an electronic mail server device, all of which are capable of using the same electronic mail confirmation method.

The present invention also relates to an electronic mail confirmation system for realizing confirmation of any newly-arrived or unopened email by using a number display service with no communication charge as well as an electronic mail system, a communication terminal, an internet connection device and an electronic mail server device, all of which are capable of operating by using the same electronic mail confirmation method.

A communication terminal that is used by a user may be any of communication devices such as an internet facsimile, facsimile, telephone set, portable telephone set, PHS telephone set, pager, cordless extension or image forming devices such as a digital copier and remote scanner or information processing devices such as a personal computer (PC) and PDA (personal digital assistant) portable information terminal, all of which are capable of being connected to a public telecommunication network and of sending and receiving information in electronic form via the Internet or a private network.

Generally, an electronic mail (email) addressed to a user arrives at an internet connection device possessed by an ISP (Internet Service Provider) and stored in an server device provided thereat, then it is transmitted to the user when s/he connected her/his communication device such as for example a personal computer to the internet connection device through a public telecommunication network and/or the Internet. Now, the user can confirm the received email by using a method for confirming the existence of a newly-arrived or unopened email, opening it and reading the content on a screen of the personal computer.

However, the above-described email confirmation method requires the user to pay a communication charge for connecting the communication terminal to an internet connection device or a server device provided at the private network (i.e., an email server device of, e.g., an intra-network providing the specific email function) every time when the user may confirm the existence of a newly-arrived email or unopened email in the internet connection device or the server. In other words, every user is forced to bear the communication charge every time when s/he only wants to confirm whether a newly-arrived or unopened email exists in the connection device and/or the server. The communication charge is wasted if there is no email. Examples of such email confirmation methods are as follows:

Japanese Laid-Open Patent Publication No. 10-190726 discloses a communication system, a communication terminal and an email device, which are easy-to-operate and have high-speed response. Namely, a fixed terminal such as a personal computer examines at certain constant intervals whether an email addressed to the user arrives at and held in a server. If there is an email, then the terminal receives the email and transmits a request signal to a charger connected thereto to confirm that a portable terminal is put on the charger. In response to the request signal, the charger confirms the presence or absence of the portable terminal thereon and transmits a response signal to the fixed terminal.

When the response indicates the presence of the portable terminal on the charger, the fixed terminal judges the presence of the user thereabout and does nothing. On the other hand, when the response indicates the absence of the portable terminal on the charger, the fixed terminal decides the absence of the user thereat and directly transmits the received email to the portable terminal the user may be carrying.

Japanese Laid-Open Patent Publication No. 11-136308 titled “Network accessing method” discloses an accessing system whereby a server may store communication data addressed to a client (user) and may transmit communication data to the client (user) at its own timing over a data channel using a public telecommunication network. Namely, the server holds a table of clients' names and their telephone numbers in pairs and makes a telephone call to the client (user) over a public telecommunication network (i.e., it sends a call by dialing the number).

As soon as the connection to a modem channel of the client's terminal was established, the server transmits an identifier requiring the client to access the server from the client (user). On receipt of the identifier, the client (user) switches off the modem connection with the server and then makes a call to the server to access the server and receive the communication data stored therein. When the server stores data to be sent to the client (user), the server makes a call to the client (user) and the client makes a call to the server in return to receive data from the server. This method enables the client (user) to receive the data without using an excessive resource and the server to transmit the data to the client with no security problem.

Japanese Laid-Open Patent Publication No. 2000-57068 titled “email-arrival confirming system and email receiving device” discloses an email receiving device and an email-arrival confirming system, which are simple in construction with a simple facility for informing of the arrival of an email. The email-arrival confirming system for informing a user of the arrival of an email comprises a computer operating under the programmed control, a display unit operating under the computer control, an email-arrival recognizing means for recognizing the arrival of an email and an email-arrival indication device for indicating the recognition of the arrived email.

The email arrival recognizing means sends a call to an email server at a specified interval to inquire whether an email addressed to the user's device arrived thereat. When there was an email in the server, the email arrival recognizing means recognizes the arrival of the email and gives a command to the email arrival indicating device that in turn lightens or flashes an LED lamp indicating the arrival of the email and causes the display unit to indicate the arrival of the email. At this time, if the screen saver is operating, the display unit cancels the screen saver and indicates the arrival of the email.

As described above, a technique for confirming the presence of an email by calling a server from a communication terminal, a technique for informing a user of arrival of an email by calling from a server side and a technique for displaying information about the presence of a received email have been disclosed by the prior arts.

However, there has been no disclosure of such a technique that enables an user's communication terminal to make a call for inquiring about the presence of an electronic mail (email) addressed to the user in an email server of the Internet Service Provider (ISP) (i.e., an internet connection device possessed by the ISP or an server with an email function used in a private network) free of charge by using the number display service (i.e., calling party information display service) and to receive a response call from the email server (i.e., the internet connection device or the server) indicating a response to the user's inquiry about the existence of an email therein.

As described before, according to a conventional electronic mail system wherein an electronic mail is transmitted and received over the internet or a private network system via a public telecommunication network, an email arrived at an internet connection device possessed by an internet service provider on the Internet or at a server having an electronic mail function provided on the private network is temporally stored in a server provided at the internet connection device used in the Internet or in the email server provided on the private network.

As soon as a user's communication terminal such as for example a personal computer to which the email is finally addressed was connected to the internet connection device or the server over the public telecommunication network and/or the Internet or the private network, the email stored in the internet connection device or the server is delivered to the user's communication terminal (personal computer). According to this system, the arrival of the email addressed to the user at the internet connection device or the server device may be confirmed by the user on the personal computer to which the email is then delivered.

However, this conventional arrival-of-email confirming method requires the user to connect the communication terminal to the internet connection device or the server device via the public telecommunication network at own expense whenever s/he tries to confirm the arrival of an email at the internet connection device or the server device. The communication charge may be wasted if no email arrived at the internet connection device or the server device.

On the other hand, there may be an email which content must be urgently informed of or dealt with, it is necessary for every user to frequently confirm the presence of newly-arrived or unopened emails in the Internet connection device or the server device by connecting the terminal device thereto through the public telecommunication network. The user must expect to pay waste communication charges.

### SUMMARY OF THE INVENTION

Accordingly, a primary object of the present invention is to provide an electronic mail confirmation system that enables each user to confirm the arrival of email at an internet connection device or a server device at desirable intervals by sending an inquiry call thereto with no communication charge by using a number display service (caller ID service in USA) provided by the public telecommunication network and to provide an electronic mail system using the same electronic mail confirmation system and a communication terminal device, an internet connection device and an electronic mail server device, all of which are adapted to use the same electronic mail confirmation system.

In the email-arrival confirmation system, an internet connection device (i.e., an internet connection device for receiving and storing emails sent thereto over the Internet) and a server device of a private network (i.e., a server device for storing emails to be sent and received over the private network such as an intranet) possess their own telephone numbers used specially for receiving inquiry calls from users. Each user sends an inquiry call to the internet connection device or the server of the private network by dialing the corresponding specified telephone number when wanting to know whether a new or unopened email has arrived and stored therein.

In this system, the internet connection device or the private network server device receives the user's inquiry call and identifies the inquiring user by using the number display service of the public telecommunication network, by which the called subscriber can be advised of the caller's telephone number (i.e., telephone number of the user's terminal making the inquiry call) as information about the calling party. Having identified the user, the internet connection device or the server does not return an answering signal to the public telecommunication network and immediately rejects the connection thereto. Namely, the device or the server disconnects the call connection without proceeding to the chargeable communication phase, thus preventing the user from being charged for the communication over the public network.

Furthermore, the internet connection device (or the server device) that has received the inquiry call recognizes the presence or absence of a newly-arrived or unopened email addressed to the identified user by retrieving emails stored therein and sends to the user's terminal a calling signal in response to the user's inquiry call by using corresponding one of two different telephone numbers selectable depending upon the presence or absence of the email addressed to the user.

The user's terminal receives the response call from the internet connection device or the server device and recognizes the telephone number displayed on his/her terminal by using the number display service of the public telecommunication network, thus confirming the presence or absence of a newly-arrived or unopened email therein by the indicated telephone number. In this instance, the user's terminal does not send an answering signal to the call and immediately disconnects the connection thereto, thus preventing the chargeable communication over the public telecommunication network.

By repeating the calling and disconnecting operations at both partied by using the number display service provided by the public telecommunication network, it is possible for each user to obtain information about the presence or absence of a newly-arrived or unopened email in the internet connection or the server device with no communication charge for call connection via the public telecommunication network. Namely, the proposed system enables the user terminal and the connection device (or the server device) to automatically repeat the inquiry-response operation at any desirable intervals.

Another object of the present invention is to provide an electronic mail confirmation system whereby an internet connection device or a private network server device for storing emails transmitted to/from each of users' (clients') communication terminals capable of transmitting an email thereto over a public telecommunication network, which devices can identify each user's call as an inquiry about the presence/absence of a newly-arrived or unopened email addressed to the user by the fact that the call has been connected thereto by dialing by the user a specified called-only telephone number attached to the connection device or the server device.

Another object of the present invention is to provide an electronic mail confirmation system whereby the internet connection device or the private network server device can identify a user having made a call for inquiring about the presence/absence of a newly-arrived or unopened email addressed to the user on the basis of the calling telephone number informed by the number display service provided by the public telecommunication network.

Another object of the present invention is to provide an electronic mail confirmation system whereby the internet connection device or the private network server device can immediately disconnect the connection with a user's call for inquiry about a newly-arrived or unopened email on completion of identification of the calling telephone number noticed by the number display service of the public telecommunication network without returning an answering signal not to proceed to the chargeable communication phase.

Another object of the present invention is to provide an electronic mail confirmation system whereby the internet connection device or the private network server device can inform a user of the presence of a newly-arrived or unopened email addressed to the user (or the absence of a newly-arrived or unopened email if such reply was requested in advance by the user) by sending a response call to the user's communication terminal over the public telecommunication network.

Another object of the present invention is to provide an electronic mail confirmation system whereby a user communication terminal having sent an inquiry call to an internet connection device or a private network server device can receive a call sent from the internet connection device or the server device and recognize it as a response to the inquiry according to the caller telephone number noticed by the number display service of the public telecommunication network.

Another object of the present invention is to provide an electronic mail confirmation system whereby a user communication terminal can receive a response call from an internet connection device or a private network server device, recognize the call as a response to the inquiry on the basis of the calling party telephone number informed by the number display service of the public telecommunication network and immediately cancel the connection thereto without answering to the call not to proceed to the chargeable communication phase.

Another object of the present invention is to provide an electronic mail confirmation system whereby an internet connection device or a private network server device decides there is a newly-arrived or unopened email to be noticed if at least one of existing newly-arrived or unopened emails addressed to the user corresponds to the response condition specified in advance by the user and that condition means to send a response call informing of the presence of a newly-arrived or unopened email addressed to the user only in the described case.

Another object of the present invention is to provide an electronic mail confirmation system whereby the response condition specified in advance by the user comprises any one or more items specifying such as importance level, sender's name, character string of a subject, reply or forwarding condition, transmitted or received period, presence of attached file and addressee's name.

Another object of the present invention is to provide an electronic mail confirmation system whereby an internet connection device or a private network server device possesses two specified different telephone numbers usable as caller numbers for sending a response call to the user through the public telecommunication network by using one of the different number for informing of the presence of a newly-arrived or unopened email addressed to the user and the other for informing of the absence of the email.

Another object of the present invention is to provide an electronic mail confirmation system whereby an internet connection device or a private network server device possesses two or more specified different telephone numbers usable for sending a response call to the user through the public telecommunication network by selectively using different telephone numbers depending upon the number of existing newly-arrived or unopened emails addressed to the user, including the case of no email being stored therein.

Another object of the present invention is to provide an electronic mail confirmation system whereby a user's communication terminal is enabled to automatically generate an inquiry call for inquiring about the presence of a newly-arrived or unopened email addressed to the user and send it to an internet connection device or a private network server device through a public telecommunication network according to the call starting conditions preset by the user.

Another object of the present invention is to provide an electronic mail confirmation system whereby the call starting conditions preset by the user for driving his/her communication terminal to make an inquiry call to the internet connection device or server device include one or more of starting conditions: specified intervals, every specified hours, each time of switching on the terminal or each time of making a request for preparing an email.

Another object of the present invention is to provide an electronic mail confirmation system whereby a response call from the internet connection device or the server device is sent to a user's communication terminal having made an inquiry call or a communication terminal designated in advance by the user as the terminal for receiving the response call.

Another object of the present invention is to provide an electronic mail confirmation system whereby when a user's communication terminal recognizes a response call received from the internet connection device or the server device and informs the user of the result of confirming the presence of newly-arrived or unopened emails by outputting voice information or audio signal through a speaker or handset and/or displaying visual information on a display unit and/or printing information on a printer of the user's communication device.

Another object of the present invention is to provide an electronic mail system using the above-described electronic mail confirmation system.

Another object of the present invention is to provide a communication terminal device using the above-described electronic mail confirmation system.

A further object of the present invention is to provide an internet connection device using the above-described electronic mail confirmation system.

A still further object of the present invention is to provide an email server device using the above-described electronic mail confirmation system.

### BRIEF DESCRIPTION OF THE DRAWINGS

FIG. 1 is an exemplary network configuration showing a connection route of an internet facsimile apparatus to the Internet or a private network via a public telecommunication network or a local area network (LAN).

FIG. 2 is a construction block diagram of an internet facsimile apparatus usable as an exemplified user's communication terminal according to the present invention.

FIG. 3 is an exemplified construction block diagram of a cordless extension set.

FIG. 4 is a conceptual illustration for explaining a number display service, i.e., a calling number display service provided in Japan.

FIG. 5 is a conceptual illustration for explaining a number display service, i.e., a calling number display service provided in USA.

FIG. 6 shows the correct alignment of the drawing sheets for FIGS. 6A and 6B.

FIGS. 6A and 6B are flowcharts depicting a procedure of electronic mail confirmation according to the present invention.

### PREFERRED EMBODIMENT OF THE INVENTION

A preferred embodiment of the present invention regarding an electronic mail confirmation system and an electronic mail system, a communication terminal, an internet connection device and an electronic mail server device, all of which are capable of using the same electronic mail confirmation system, will be described bellow with reference to the accompanying drawings.

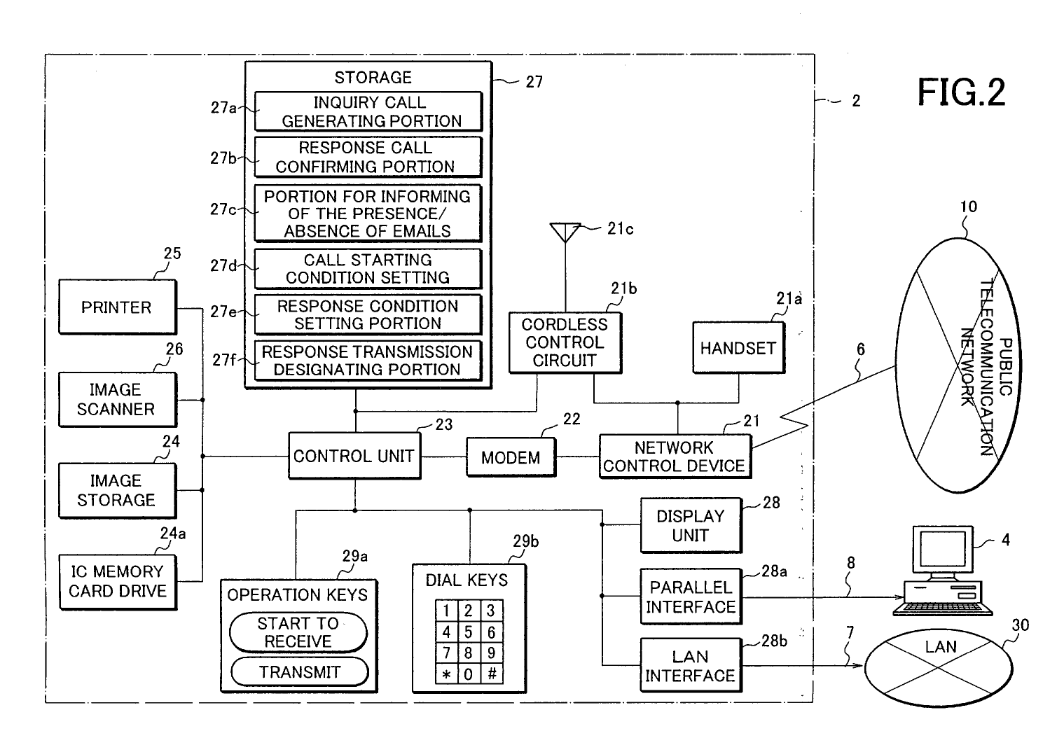

The communication terminal device used by a user in the electronic mail system of the present invention may be any one of communication and information processing apparatuses which are capable of being connected to a public telecommunication network and transmitting and receiving electronic mails. In the preferred embodiment, an internet facsimile apparatus is used by way of example as the user's communication terminal, which is further explained with reference to FIG. 2.

FIG. 2 is a block diagram of an internet facsimile apparatus usable as an example of user's communication terminal device according to the present invention. In FIG. 2, an internet facsimile apparatus 2 used as a user's information terminal is connected through a network control device 21 via a telephone line 6 to a public telecommunication network 10 composed of telephone/ISDN lines and it can transmit and receive various kinds of information (including electronic mails) to and from another internet facsimile apparatus or any other kind of communication terminals such as for example a personal computer and a portable communication terminal or an internet connection device (i.e., an internet connection device for storing emails to be transmitted and received over the Internet) or a private network server device (i.e., a server device for storing emails to be transmitted and received over a private network such as an Intranet).

The network control device 21 monitors the traffic of the public telecommunication network 10 and has a function for switching the telephone line (communication line) 6 from a telephone set 21a to a modem 22 or reverse. The modem 22 converts digital signals of image data into analog signals suitable for transmission over the public telecommunication network 10 and converts analog signals of image data received over the public telecommunication network 10 into original digital signals suitable to be printed. At the same time, the modem 22 is used to modulate/demodulate various types of information to be transmitted to and received from other communication terminals and internet or intranet devices over the public telecommunication network 10. Furthermore, it is used to demodulate an incoming stream of data of 1,200 bps, which is information about a calling party (i.e., a calling party telephone number) and transmitted together with a corresponding calling signal from the public telecommunication network 10 by the number display service (i.e., calling number display service provided by the public telecommunication network 10) as described later.

A printer 25 is used to print image data transmitted from the public telecommunication network 10 or read by an image scanner 26 on a recording paper.

It may be of thermal, electrographic or ink-jet printing type. The image scanner 26 has a function for reading an original image data and converts it into digital form so that it can be transmitted over the public telecommunication network 10 and copied on the printer 25. It may be of the contraction reading type using a combination of a lens with a CCD line sensor or of the contact sensor type using a rod lens array.

An image storage 24 is used for storing image data read by the image scanner 26 and images received from the public telecommunication network 10. The provision of the image storage 24 enables the control unit 23 to execute programs stored in a storage 27 for realizing a number of complex functions such as for example transferring a received image, broadcasting, intercepting in the event of no paper feeding, transmission by memory and so on.

An IC memory card device 24a is a drive memory in which an IC memory card is removably loaded for recording thereon image data obtained from the outside and for writing image data to be used by the outside. It can be also used to read/write programs and data from/on the IC memory card.

The control unit 23 executes programs (instructions) stored in the storage 27 and controls the operation of the internet facsimile apparatus 2 based on information input from operation keys 29a and dial keys 29b, information from components of the internet facsimile apparatus or various kinds of signals received from the public telecommunication network 10 by sending commands to the respective components and causing a display 28 to indicate the necessary message.

By executing programs stored in storage 27, the control unit 23 causes the facsimile apparatus to transmit/receive image information and emails or compress image information to save the time of transmission or expand a compressed image signal to an original pixel image.

Furthermore, the control unit 23 executes various kinds of program instructions stored in the storage 27 to transmit a call for inquiring about the presence or absence of a newly-arrived or unopened email addressed to a user of this internet facsimile apparatus 2 to an internet connection device (i.e., an internet connection device for storing electronic mails to be transmitted or received over the Internet) or a private network server device (i.e., a server device for storing electronic mails to be transmitted and received over the private network such as an intranet) (by the operation of an inquiry call generating portion 27a). Furthermore, the control unit 23 receives a response call transmitted from the internet connection device or the server device in response to the inquiry call made by the facsimile apparatus (by the operation of a response call confirming portion 27b) and informs the user of the result of confirmation of the response to the inquiry about the presence or absence of emails by displaying information on a display unit 28 or outputting voice information or an audio-signal through a speaker or a handset 21a or by printing information on paper by a printer 25 (by the operation of a portion 27c for informing of the presence or absence of emails).

By further executing programs stored in the storage 27, the control unit 23 controls the operation of setting the call starting conditions (timings) for automatically transmitting the above-described inquiry call by using operation keys 29a (by the operation of a call starting condition setting portion 27d). For example, the conditions for automatically sending the inquiry call can be preset by the user so that the call may be automatically transmitted at specified intervals, every fixed time of day, every time of starting the apparatus or every time of requesting for preparing an electronic mail or any combinations of the above timings.

By further executing programs stored in the storage 27, the control unit 23 controls the operation of setting the conditions applied to the above-described response call to be received from the internet connection device or the server device by using operation keys 29a (by the operation of a response condition setting portion 27e). The response condition specifies features of a newly-arrived or unopened email that is worthy for the user to be noticed of its presence by a response call from the internet connection device or the server device.

Exemplary response conditions are as follows: The newly-arrived or unopened emails addressed to the user shall be checked for: Importance level (only emails having the importance not lower than the predetermined level are selected); sender's name (only emails from specified senders are extracted); a character string contained in the subject (only emails containing a predetermined character string in its subject-title are extracted); reply or transferred emails (only replied/transferred emails are extracted or excluded); transmitted or received period conditions (only emails transmitted or received in a predetermined period (year, month, day and hour) are extracted); attachment condition (only emails having a file attached thereto are extracted); addressee's name (in case if two or more users' names have been registered, only emails addressed to a designated person are extracted). Any one or more conditions can be set and registered in advance in the Internet connection device and/or the private network server device.

The response conditions are applied as follows: The internet connection device or the server device retrieves the newly-arrived or unopened emails addressed to the user who has made an inquiry call and determines whether any one of the emails corresponds to the specified conditions predetermined and registered by the user. If there is found an email having satisfied the response condition, then a response call is generated and transmitted by the connection device or the server device to the user's communication terminal to inform of the presence of the newly-arrived or unopened emails being stored therein. In the case if the newly-arrived or unopened emails exist but none of them corresponds to the specified conditions, the connection device or the server device decides there is no email to be reported to the user and treats in the same way as in the case there is no newly-arrived or unopened email addressed to the user.

By using programs stored in the storage 27, the control unit 23 enables the user to set by means of operation keys 29a such an information condition that in the case when no newly-arrived or unopened email was found or none of the newly-arrived or unopened emails did not comply with the specified conditions, a response call informing the user of the absence of email (to be noticeable) is transmitted to the user's communication terminal. This information condition can be registered in advance in the internet connection device or the private network server device.

By using programs stored in the storage 27, the control unit 23 can also control the operation of designating the communication terminal to which a response call of the internet connection device or the private network server device shall be transmitted (by the operation of a response call designating portion 27f). Namely, it is possible for the user to designate by using operation keys 29a a communication terminal to which the response call shall be transmitted (e.g., a cordless portable terminal composing an extension of a fixed communication terminal).

The operation keys 29a and dial keys 29b are devices for the user to input information and instruction into the internet facsimile apparatus (communication terminal) 2. A display unit 28 is used to indicate various kinds of information and guidance for the user from the internet facsimile apparatus 2.

The internet facsimile apparatus 2 is provided with three kinds of interfaces for connection with the external networks such as the Internet and other private networks (for example an intranet). Namely, the apparatus 2 has a network control device 21 for connection to the public telecommunication network 10 through a telephone line 6, a parallel interface 28a directly connectable with a parallel cable to a personal computer PC 4 capable of being connected to the Internet and other private networks and a LAN interface (LAN I/F) 28b for connection with LAN (Local Area Network) 30 with a LAN cable 7.

The interface for directly connecting the internet facsimile apparatus 2 to the personal computer PC 4 is not limited to the parallel interface 28a using the parallel cable 8 and may be of other types such as for example a USB interface, a serial interface, SCSI interface and so on.

However, the present invention is not limited to the case of the internet facsimile apparatus 2 provided with three kinds of interfaces as shown in FIG. 2. It is necessarily provided with the network control device 21 only for connection though the telephone line 6 to the public telecommunication network 10. Other interfaces may be provided if the need be.

For example, the internet facsimile apparatus 2 through only the network control device 21 can carry out telephone and facsimile communications with other terminals and can exchange information with servers and computers operating on the Internet or intranet or LAN.

In other words, the provision of the network control device 21 enables the internet facsimile apparatus 2 to communicate with all other external devices through the public telecommunication network 10. Three kinds of interfaces shown in FIG. 2 are typical examples of connecting the communication terminal to the Internet and other private networks. The internet facsimile apparatus 2 according to the present invention is necessarily provided with the network control device 21 and has no need of having all three kinds of interfaces.

The internet facsimile apparatus 2 includes a cordless control circuit 21b and antenna 21c for control the connection with a portable cordless terminal that is an extension set of the stationary facsimile apparatus 2.

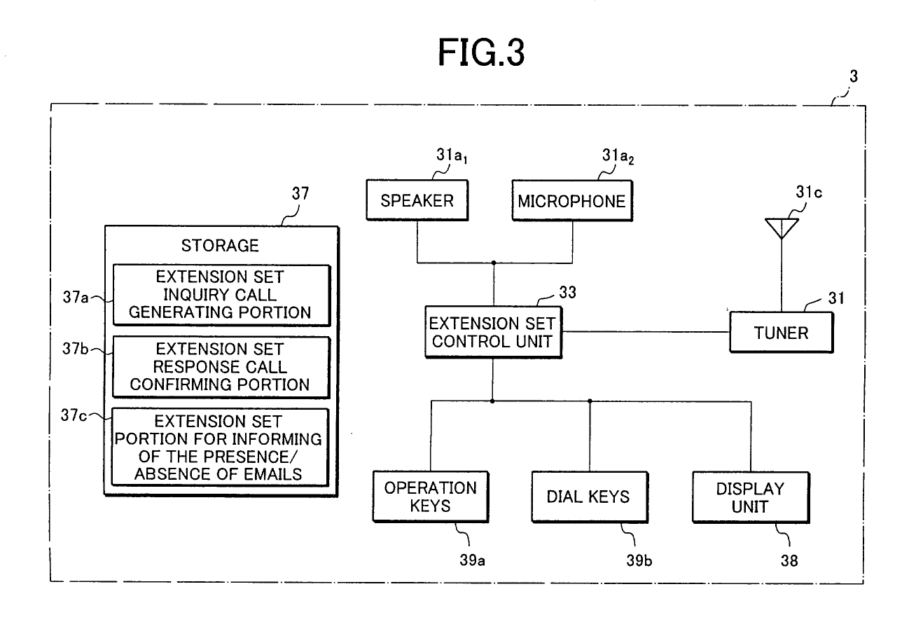

Referring now to FIG. 3, an exemplary construction of a portable cordless extension set is described, which set can operate as another communication terminal to realize the electronic mail confirming system according to the present invention. FIG. 3 is a construction block diagram of the cordless terminal that is used as an extension set of the internet facsimile apparatus 2 and is connected thereto by radio through the antenna 21c. Namely, this extension set 3 is portable and therefore its interface limited to communication by radio tuner 31 and an antenna 31c. It is not provided with an image reader and a printer to realize saving in size and weight of the body. This extension set 3 is miniaturized but similar in construction to the main facsimile apparatus shown in FIG. 2.

Namely, the cordless extension set 3 is provided with a speaker 31a₁/microphone 31a₂, display unit 38, operation keys 39a and dial keys 39b, which correspond respectively to the handset 21a, the display unit 28, operation keys 29a and dial keys 29b of the internet facsimile apparatus 2. These components of the extension set are of course smaller and lighter.

By fetching and executing programs stored in a storage 37, an extension control unit 33 controls the operation of a whole system of the cordless extension set 3 and controls the tuner 31 to set and release the radio communication channel necessary for communication with the internet facsimile apparatus 2. Radio signals usable for communication with the internet facsimile apparatus 2 may be any of digital and analog in the embodiments of the present invention.

By fetching and executing programs stored in a storage 37, this extension control unit 33 controls the transmission of a call for inquiry about the presence of emails addressed to the user to either the internet connection device or the server device through the internet facsimile apparatus 2 (by the operation of an extension set inquiry call generating portion 37a) and the reception of an response call from the internet connection device or the server device through the internet facsimile apparatus 2 (by the operation of an extension set response call confirming portion 37b). It informs the user of the confirmation result of the inquiry about the presence of emails according to the response call by indicating information on the display unit 38 and outputting a voice or audio signal through the speaker 31a₁ (by the operation of an extension set portion 37c for informing of the presence/absence of emails).

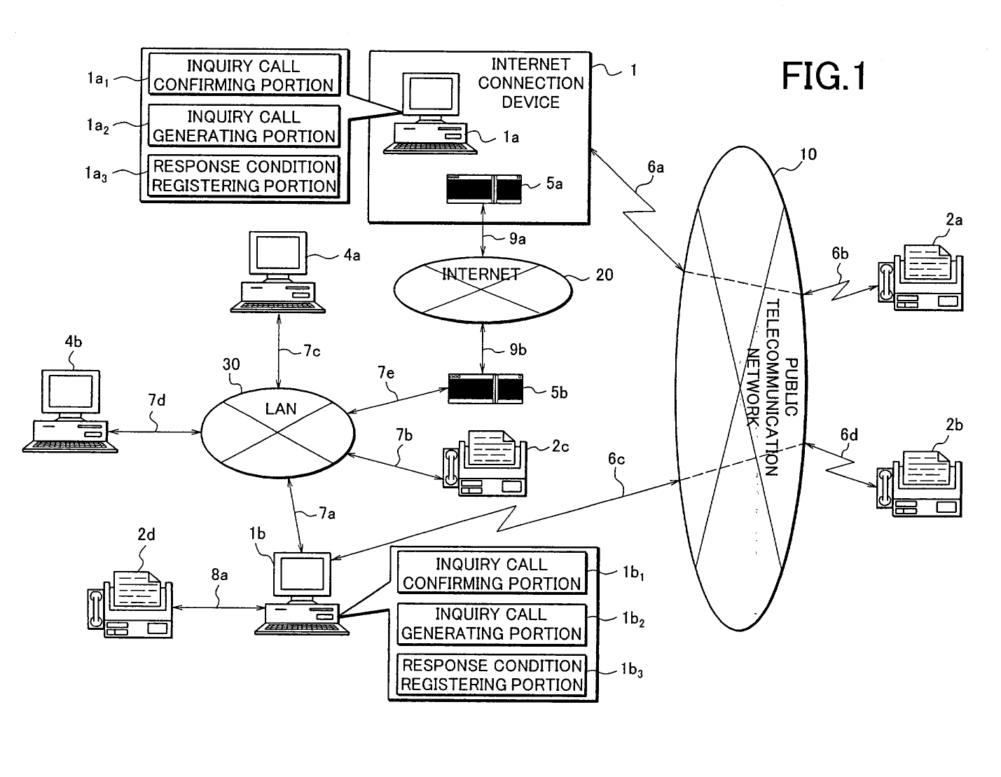

FIG. 1 shows an exemplary construction of networks wherein the internet facsimile apparatus shown in FIG. 2 (including a cordless extension set 3 shown in FIG. 3 as one component to simplify the description hereinafter), an internet connection device, a server device and various kinds of information terminals (such as for example personal computers) are interconnected each other through the networks. FIG. 1 is also illustrative of exemplary routes of connecting the internet facsimile apparatuses to the Internet and a private network through the public telecommunication network or a LAN (local Area Network).

In FIG. 1, the third internet facsimile apparatus 2c for business use is connected to the Internet 20 through LAN 30 and a router 5b composing an office LAN and the first internet facsimile apparatus 2a for personal use is connected to an internet connection device 1 provided by an internet service provider (ISP) through a public telecommunication network 10 composed of telephone/ISDN lines and further through the internet connection device 1 to the Internet 20. The latter route for connection to the Internet 20 through the internet connection device 1 is identical to the connection route used by most of personal communication terminals.

In FIG. 1, there is still shown the second internet facsimile apparatus 2b connected through the public telecommunication network 10 to a server device 1b connected to LAN 30 (private LAN) and the fourth internet facsimile apparatus 2d directly connected with a parallel cable 8a to the server device 1b. The second and fourth internet facsimile apparatuses 2b and 2d may be further connected to the Internet 20 through the server device 1b, LAN 30 and the router 5b or the public telecommunication network 10 and the internet connection device 1.

Connection routes to the Internet other than the above described may be possible for example through radio channels. However, the present invention is applied to the connection routes to the internet connection device 1 of the Internet through the public telecommunication network 10 composed of for example telephone/ISDN lines or to the server device 1b used on the office LAN 30 (private network) through the public telecommunication network 10. More specifically, these connection routes may cause the communication parties to pay a communication charge to the public telecommunication network service whenever they are connected to each other. It is also premised that the internet connection device 1 and the server device 1b are capable of transmitting/receiving electronic mails and storing them therein and the public telecommunication network 10 provides the number display service.

Namely, the present invention is directed to the connection routes passing through the public telecommunication network 10. In case of FIG. 1, communication terminals to which the present invention is applied are the first internet facsimile apparatus 2a connected through the public telecommunication network 10 to the internet connection device 1 and the second internet facsimile apparatus 2b connected intranetly to the server device 1b of the private network through the telecommunication network 10. On the other hand, the third internet facsimile apparatus 2c connected to the Internet 20 through the LAN 30 and the router 5b composing an office LAN and the fourth internet facsimile apparatus 2d connected directly to the server device 1b by using for example a parallel cable 8a are out of the scope of the present invention.

The networks shown in FIG. 1 are described further in detail. For example, in case of building up an office LAN as a private network, a server device 1b (or a plurality of server devices) and a number of communication terminals (clients) such as for example personal computers PC and facsimile apparatuses (similar in construction to the internet facsimile apparatus 2) are connected to LAN 30. The server device 1b connected to LAN 30 holds various kinds of data such as text data, image data, facsimile image data and audio data, which were received from the clients' communication terminals and the Internet 20 and can provide various kinds of information services by request of the clients.

In FIG. 1, there is shown by way of example the first personal computer 4a, the second personal computer 4b and the third internet facsimile apparatus 2c as communication terminals that are clients of the office LAN system. Each of the client communication terminals can access the server device 1b and the Internet 20 through LAN 30 and the router 5b. There is also shown an exemplary route of connecting the third internet facsimile apparatus 2c to the Internet 20 through LAN 30 and the router 5b. However, this connection route is not object of the present invention because it is not directly connected by the network control unit 21 to the public telecommunication network 10.

In other words, the third internet facsimile apparatus 2c is shown as an example of connection to the Internet through LAN 30 and the router 5b. The interface of the third internet facsimile apparatus 2c corresponds to the connection route to LAN 30 through a LAN interface 28b and a LAN cable 7 as shown in FIG. 2. The third internet facsimile apparatus 2c thus connected to LAN 30 is always left as connected thereto in most cases. The present invention is therefore inapplicable to the apparatus always connected to LAN 30.

In FIG. 1, the fourth internet facsimile apparatus 2d is connected directly to the server 1b by means of the parallel cable 8a and normally left as connected thereto. The connection interface of the fourth facsimile apparatus 2d directly connected with a cable to the server device 1b corresponds to the connection to the personal computer PC 4 through a parallel interface 28a and a parallel cable 8 as shown in FIG. 2. However, the apparatus 2d is not directly connected by the network control unit 21 to the public telecommunication network 10 and connected only with the server device 1b. Therefore, the present invention is not applicable to the case of the apparatus 2d.

The second internet facsimile apparatus 2b shown in FIG. 1 is in accessing the server device 1b composing the office LAN through the public telecommunication network 10 composed of telephone/ISDN lines as shown by broken line in FIG. 1. In the shown connection state, the second internet facsimile apparatus 2b must have the ability of generating and interpreting signals according to the communication protocol TCP/IP to communicate with the server 1b through the public telecommunication network 10. The interface for connecting the second internet facsimile apparatus 2b to the public telecommunication network 10 corresponds to the case of connecting the apparatus 2 to the public telecommunication network 10 through the network control unit 21 and the telephone line 6 as shown in FIG. 2. Namely, the second internet facsimile apparatus 2b using the route of directly connecting to the public telecommunication network 10 is an object to which the present invention is applied.

The first internet facsimile apparatus 2a shown in FIG. 1 has a connection route to the Internet 20, which route is normally used by most personal users in accessing the Internet. Namely, the first internet facsimile apparatus 2a is connected first to the internet connection device 1 maintained by the contracted internet service provider (ISP) as shown by a broken line in FIG. 1. Information transmitted from/to the first facsimile apparatus (client) 2a is temporarily stored in the server device 1a provided in the internet connection device 1. The apparatus 2a is further connected to the Internet 20 by the router 5a of the internet connection device 1. Information is exchanged between the client apparatus 2a and the Internet 20 by the connection route through the Internet connection device 1 based on the information stored in the server device 1a.

The interface for connecting the first internet apparatus 2a to the public telecommunication network 10 corresponds to the case of connecting the internet facsimile apparatus 2b to the public telecommunication network 10 through the network control circuit 21 and the telephone line 6 as shown in FIG. 2. The present invention is most effectively applied to the case of the first facsimile 2a that is connected directly to the public telecommunication network 10 and then to the internet connection device 1 possessed by the internet service provider.

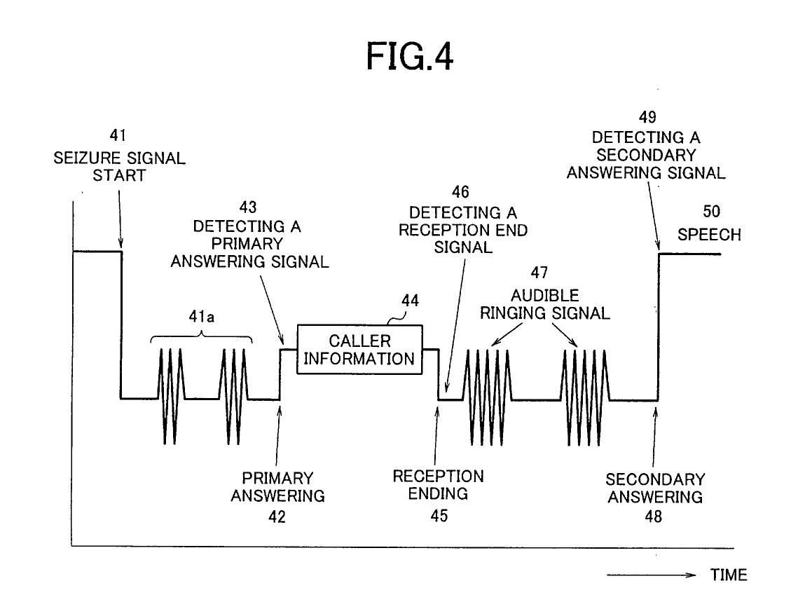

Prior to explaining the electronic mail confirming procedure according to the present invention, the number display service, i.e., the caller information (i.e., caller's telephone number) identifying the calling party, which service is provided by the public telecommunication network and forms an important component of the present invention will be described below. Referring to the conceptual illustration of FIG. 4, the number display service (i.e., calling telephone number display service) adopted by the public telecommunications networks in Japan is first explained below. The number display service (Calling telephone number display service) is a service whereby the called terminal is advised of the caller's telephone number transmitted by the public telecommunication network 10 together with the calling signal.

The concept of FIG. 4 is described by way of example with the internet facsimile apparatus 2 shown in FIG. 2. When the user (the internet facsimile apparatus 2) is called, a seizure signal 41 from a local switch (not shown) is transmitted over a two-wire telephone line 6 to the internet apparatus 2. The seizure signal 41 is produced by reversing polarities of two wires of the telephone line. Then, a non-ringing call signal 41a, which is similar to audible ringing signal of 16 Hz but different by its duration, is transmitted to the apparatus 2.

Having detected the non-ringing calling signal 41a, the network control unit 21 of the internet facsimile apparatus 2 does not output an audible ringing signal and closes two wires of the telephone line in a loop state to return a primary answering signal 42 to the local switch LS. On receipt of the primary answering signal 42 (action 43 in FIG. 4), the local switch LS transmits caller telephone number identifying the calling party (caller information 44) over the telephone line 6 to the network control unit 21. The caller telephone number (i.e., caller information) 44 is a signal according to the ITU-T recommendation V.23, which is a frequency modulated start-stop synchronized signal of 1,200 bps.

On completion of receiving the caller telephone number (caller information) 44 at the network control unit 21 and the modem 22 of the internet facsimile apparatus 2, the network control unit 21 releases the loop closed state of the telephone line to disconnect the loop and returns the reception-ending signal 45 to the local switch LS. At the same time, the received caller information 44 is recorded in the storage 27 under the control of the control unit 23.

When detecting the reception-ending signal 45 (Action 46 in FIG. 4), the local switch LS sends an audible ringing signal 47 of 16 Hz to the network control unit 21 that in turn generates the audible ringing signal and at the same time closes the two-wire circuit of the telephone line 6 in the loop state to return a secondary answering signal 48 to the local switch LS. On receipt of the secondary answering signal 48 (Action 49 in FIG. 4), the local switch LS establishes the speech path by interconnecting the both calling and called terminals and bringing them into chargeable communication phase allowing both parties to speech each other or transmit/receive image data (Action 50 in FIG. 4). The chargeable communication now begins.

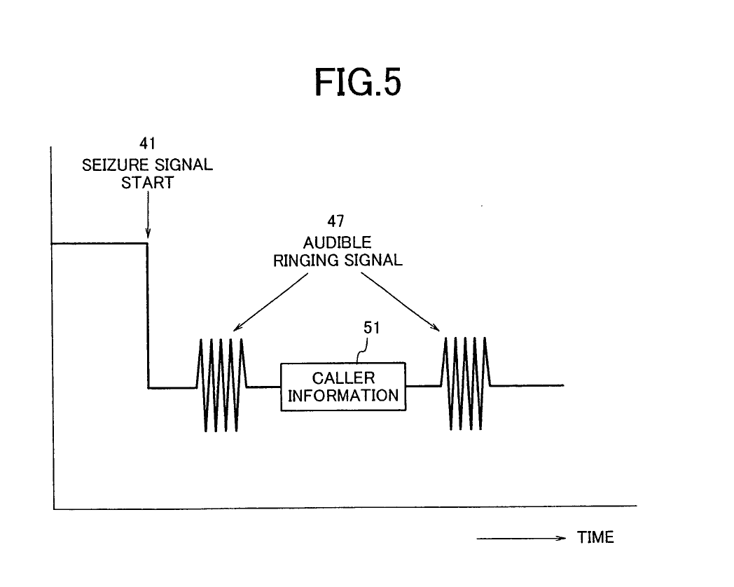

Referring now to another conceptual illustration of FIG. 5, the number display service adopted in USA is described below. The USA number display service is distinct from the Japanese number display service in that the local switch LS sends to the network control unit of the called terminal a seizure signal 41 by reversing the polarities of two wires of the telephone line, a usual audible ringing signal 47 of 16 Hz (not non-ringing call signal 41a in FIG. 4) and the caller telephone number (caller information) 51 for identifying the calling party as inserted between two audible ringing signals, i.e., in the pause of two successive ringing signals. The caller telephone number (i.e., caller information) 51 is a signal conforming to the ITU-T recommendation V.23, which is a frequency modulated start-stop synchronized signal of 1,200 bps.

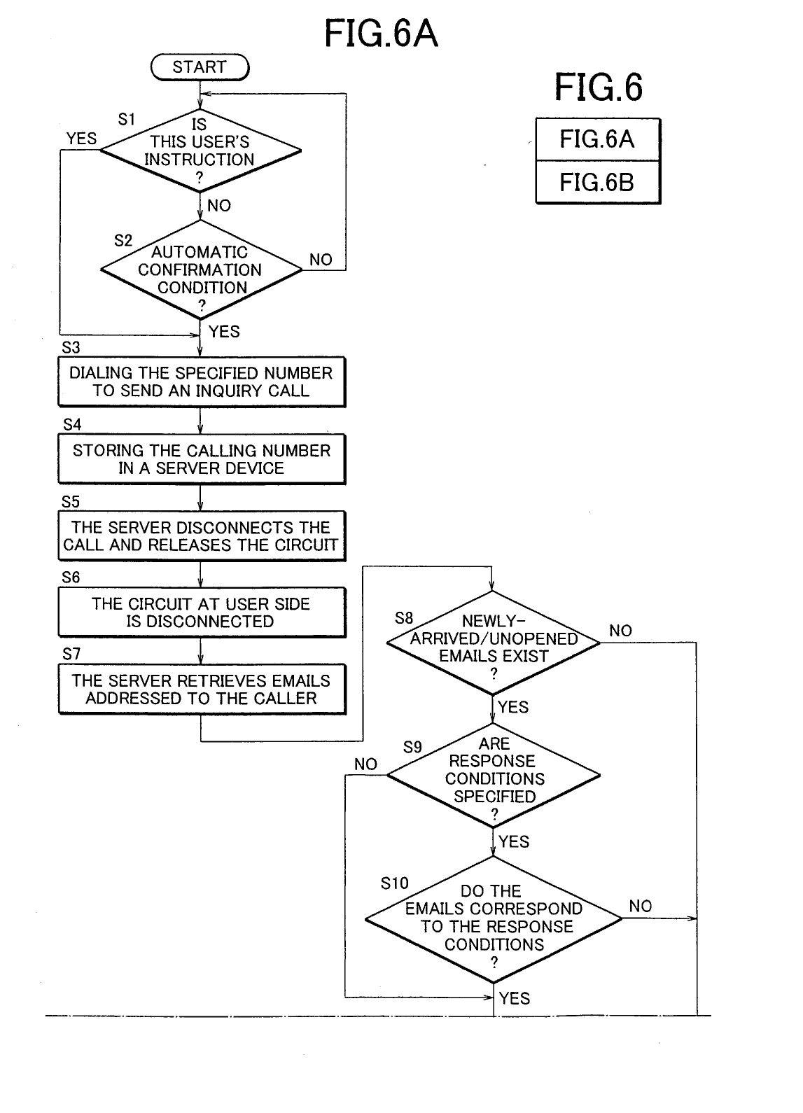

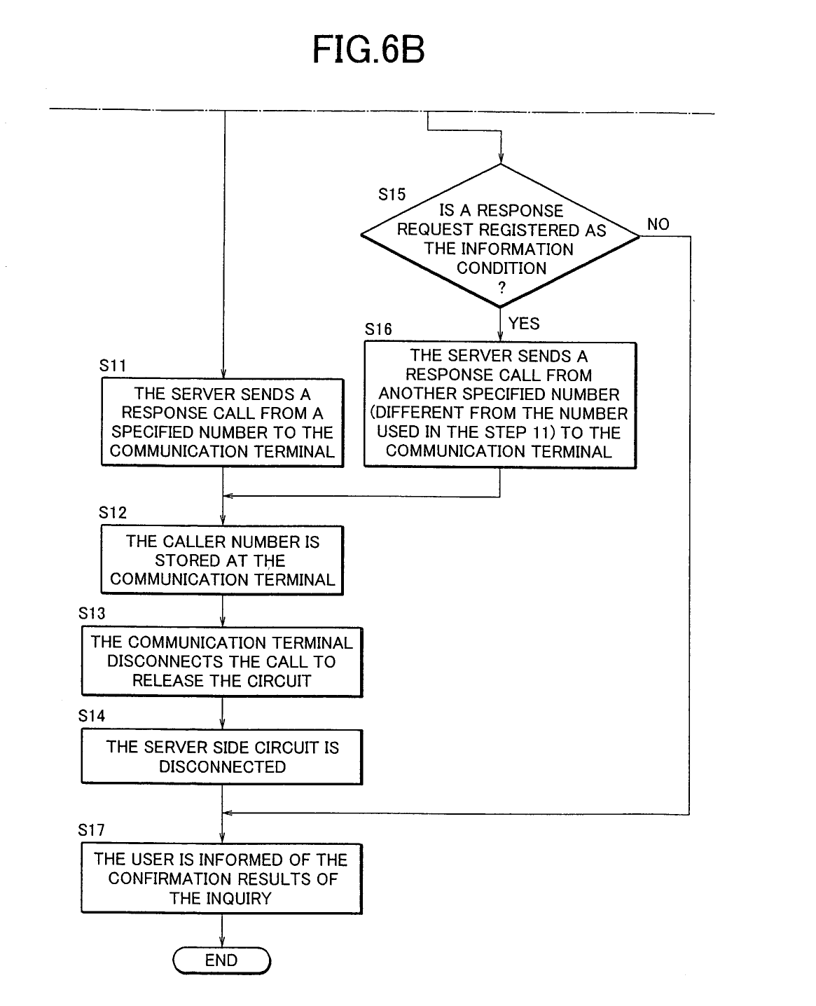

Referring now to FIGS. 6A and 6B, the email confirmation system according to the present invention is described below. FIGS. 6A and 6B are flowcharts depicting an exemplary procedure for confirming emails according to the present invention. The flowcharts of FIGS. 6A and 6B relate to the case that a user communication terminal generates an inquiry call for inquiring about the presence of newly-arrived or unopened emails addressed to the user and transmits it to either an internet connection device 1 on the Internet or a server device 1b on a private network as shown in FIG. 1 through a public telecommunication network 10 capable of providing the number display service and the internet connection device 1 or the server device 1b receives the inquiry call and generates an response call informing the user of the result of confirming the presence/absence of the emails.

The present invention may use any kinds of communication terminals that can be connected to a public telecommunication network and is capable of transmitting and receiving electronic mails. The internet facsimile apparatus shown in FIG. 2 is used by way of example in the following description of the present invention.

As described before, the response call may not always returned to the communication terminal having transmitted the inquiry call and may be transmitted to another terminal if such was preliminarily designated and registered by the user, for example, a cordless extension terminal set connected by radio to the main communication terminal as shown in FIG. 3. However, the following description is, for the simplicity, limited to the case that a response call generated in response to an inquiry call transmitted from a user's communication terminal is returned to the same user's communication terminal.

The operation program of the flowcharts of FIGS. 6A and 6B may be automatically driven if the starting condition for automatically generating an inquiry call (i.e., for automatically confirming the presence of emails) has been preset, for example, so that an inquiry call can be generated at specified time intervals.

As described before, it is possible for each user to receive a response call indicating the presence of emails only in the case any one of existing newly-arrived or unopened emails addressed to the user corresponds to the response condition predetermined and registered by the user (for example, it has an importance higher than the specified level). Namely, user can set and registers the same condition in the internet connection device 1 and the private network server device 1b.

It is also possible for the user to set in advance the information condition requesting that a response call shall be returned even if no email newly-arrived or unopened is stored or if none of emails stored corresponds to the response conditions. The information condition thus predetermined can be registered in advance in the internet connection device or the server device.

The operation program of the flowcharts shown in FIGS. 6A and 6B is driven after completion of the above-described preparation. On the internet facsimile apparatus 2 used by the user, the control unit determines whether an instruction to make an inquiry about the presence/absence of newly-arrived or unopened emails has been given by the user (Step S1). If not (No at Step S1), the control unit examines whether the present state corresponds to the starting condition (automatic confirmation condition) preset for example for automatically confirming the presence of emails addressed to the user at specified time intervals (Step S2). If present state did not correspond to the starting condition (No at Step S2), the control unit returns to Step S1 to examine whether the user's instruction is given or waits until the user's instruction is inputted or the starting condition are realized.

The starting condition, i.e., the automatic confirmation condition is the description made by the user by using the operation keys 29a, which specifies the condition for automatically starting the procedure of confirming the presence of emails. When the starting condition (automatic confirmation condition) is satisfied, the internet facsimile apparatus (user's communication terminal) 2 automatically starts the operation for generating an inquiry call for inquiring the Internet connection device 1 of the Internet 20 or the server device 1b of the private network LAN 30 about the presence therein of newly-arrived or unopened emails addressed to the user and transmitting the inquiry call to the internet connection device 1 or the server device 1b through the public telecommunication network 10.

Various conditions can be set as the starting condition, i.e., the automatic confirmation condition for starting the programmed operation of confirming the arrival of the condition. For example, the programmed operation may be started at certain time intervals predetermined by the user with consideration of the necessary frequency of confirming the arrival of important emails or at the specified time designated by the user or every time when the communication terminal is switched * on for any reason or the user makes a request for preparing an email to be transmitted or by using two or more of above settings. It is also possible for the user to prepare and preset any desirable starting condition(s). The starting condition can be preset by the operation of the starting condition setting portion 27d (FIG. 2).

When the user's instruction was given at Step S1 or the starting condition was satisfied at Step S2 (when positively answered at respective Steps), the dial-up (calling) connection to the ISP's internet connection device 1 of the Internet 20 or the server device 1b of the private network LAN 30 through the public telecommunication network 10 providing the number display service by automatically or manually dialing a preliminarily designated telephone number of the internet connection device 1 or the private network server device 1b (Step S3). On the internet facsimile apparatus 2 (FIG. 2), Steps S1 to S3 are executed by the action of the inquiry call generating portion 27a thereof (FIG. 2) or the action of the inquiry call generating portion 37a of the cordless extension set 3 (FIG. 3).

The specified telephone number of the internet connection device 1 or the server device 1b is provided specially for receiving calls of the users inquiring about the existence of newly-arrived or unopened emails addressed to them. Thus, the internet connection device 1 or the server device 1b can immediately recognize a call connected to the specified number as a user's call inquiring about the presence/absence of newly-arrived or unopened emails addressed to the user.

In other words, the user who wants to know whether newly-arrived or unopened emails are stored in the internet connection device 1 or the server device 1b connects the communication terminal thereto through the public telecommunication network 10 by dialing the specified telephone number of the internet connection device 1 or the server device 1b, which recognizes the user's inquiry call by the called specified telephone number.

The user of the communication terminal (internet facsimile apparatus 2) that transmitted the inquiry call and the managers of the internet connection device 1 and the private network server device 1b, which have received the inquiry call from the user, are clients of the number display service of the public telecommunication network 10, by which they can be advised of the telephone number of the calling party.

Namely, together with the user's inquiry call, the telephone number of the calling party (so called caller information) is also sent to the internet connection device 1 or the server device 1b from the local switch LS of the public telecommunication network 10.

The internet connection device 1 or the server device 1b having received the user's inquiry call to the specified telephone number receives the caller telephone number (i.e., the caller information) from the local switch LS by its network control unit and modem, thereby the device 1 or 1b can now identify the user inquiring about the presence of emails by the caller information received and can also identify the email address of the user based on the caller's telephone number. The caller telephone number information and the caller's email address of the identified user are stored in the email address storage (Step S4).

Namely, the Internet connection device 1 or the server device 1b can identify the caller as the user who has sent the inquiry call by dialing the specified telephone number for inquiring about the existence of newly-arrived or unopened emails addressed to him/her by knowing the caller telephone number (i.e., caller information) provided by the number display service of the public telecommunication network 10.

After this, the internet connection device 1 or the server device 1b identifies the call received by the specified telephone number as the inquiry about the existence of newly-arrived or unopened emails addressed to the user identified by the caller information and immediately disconnects the called telephone line without returning an answering signal to the public telecommunication communication network 10 in order not to establish the call and proceed to the chargeable communication phase (i.e., the communicating connection phase)(Step S5).

Namely, the internet connection device 1 or the server device 1b, which has received the call through the specified telephone line, identifies the caller as the user inquiring about the existence of newly-arrived or unopened emails by the caller telephone number noticed by the number display service and in this case disconnects without delay the user's inquiry call without returning an answering signal in order not to proceed to the chargeable communication phase with the calling party.

The line-disconnected signal from the called party is detected by the local switch LS of the public telecommunication network 10 and the internet facsimile apparatus 2 of the calling user is also released by a local switch LS to which the apparatus is connected. Then, the release signal is detected by the network control unit 21 of the internet facsimile apparatus 2 that is also restored into the initial disconnected state (Step S6).

The operation (Steps S4 to S5) of the internet connection device 1 (or the server device 1b) is executed by the operation of the inquiry call confirmation portion 1a₁ provided in the server 1a of the internet connection device (or the inquiry call confirmation portion 1b₁ provided in the server device 1b). The line disconnection at the internet facsimile apparatus 2 (at Step S6) is executed by the action of the inquiry call generation portion 27a (FIG. 2) or the inquiry call generation portion 37a of the cordless extension terminal set (FIG. 3).

Since this inquiry call ends in the call starting phase and does not run into the chargeable communication phase, it is a no-charge call. Therefore, the user is allowed to complete a call for inquiry about the existence of newly-arrived or unopened emails to the internet connection device 1 or the server device 1b over the public telecommunication network with no charge.

The internet connection device 1 or the server device 1b, which has been requested by the user's inquiry call to the specified telephone number to confirm the existence of newly-arrived or unopened emails addressed to the user, retrieves first the emails stored for the user based on the caller information and the email address stored in the storage (Step S7). The device confirms the presence/absence of newly-arrived or unopened emails (Step S8).

When newly-arrived or unopened emails exist (Positively answered (Yes) at Step S8), the device 1 (or 1b) examines whether the response condition regarding emails worthy or needed to be confirmed by a response call has been set and registered (Step S9). The response condition predetermined by the user on the internet facsimile apparatus 2 by using the response condition setting portion 27e thereof (FIG. 2) has been registered in the server device 1a of the Internet connection device 1 by the operation of the response condition registering portion 1a₃ thereof or in the private network server device 1b by the action of the response condition registering portion 1b₃ thereof.

In the internet connection device 1 or the server device 1b, the presence of emails is decided only in the case when any one of newly-arrived or unopened emails stored for the user corresponds to the response condition registered therein. More strictly, the device decides that there is an email (or emails) requiring the device to inform the user of its existence by returning a response call.

On the other hand, when there are newly-arrived or unopened emails addressed to the user but none of them corresponds to the response condition, the device 1 or 1b decides that there is no email that the device has to inform the user of its existence by a response call. Namely, this case is treated as the same when there is no newly-arrived or unopened email addressed to the user.

It is possible for user to preset and register for example such a response condition that he/she must be informed of the existence of emails by a response call only in the case there is any email having the importance equal to or higher than the specified level or there is an email(s) from the specified sender(s).

More specifically, the response condition may include any one or more items such as for example an importance level, the sender's name, a string of characters in the subject, a returned or forwarded email, transmitted or received period, the presence of an attached file, an addressee's name and so on. The response condition thus predetermined by the user may be registered in advance in the internet connection device 1 or the server device 1b. The devices of the system according to the present invention thus enable each user to realize the adaptive inquiry for confirming the presence of emails according to the conditions optionally preset by each user.

In the case that the response condition has been set and registered (Positively answered at Step S9), the internet connection device 1 or the server device 1b examines whether an email corresponding to the response condition exists among newly-arrived or unopened emails (Step S10). If there is at least one email corresponding to the response condition (positively answered at Step S10) or if no response condition was registered (Negatively answered at Step S9), the user shall be informed of the presence of newly-arrived or unopened emails by a response call.

The internet connection device 1 or the server device 1b has two different telephone numbers specially used for transmitting two kinds of response calls for informing the user of the presence/absence of newly-arrived emails to the user's communication terminal (internet facsimile apparatus 2) from which the user transmitted the inquiry call. Namely, one of two calling lines is used for sending a response call for informing of the presence of newly-arrived or unopened emails addressed to the user and the other is used for sending a response call for informing of the absence of a newly-arrived or unopened email addressed to the user.

Furthermore, the internet connection device 1 or the server device 1b may use two or more different telephone numbers (lines) selectively used for sending different kinds of response calls to the user. In this case, two or more telephone numbers may be selectively used depending on the number of existing new-arrived or unopened emails including the case there is no email addressed to the user.

Namely, the internet connection device 1 or the server device 1b having two or more different telephone numbers may not only inform the user of the presence or absence of newly-arrived or unopened emails addressed to the user but also advise of the number of emails stored therein by respective different telephone numbers.

If there is an email corresponding to the response condition (positively answered at Step S10) or if there is no register of the response condition (negatively answered at Step S9), the internet connection device 1 or the server device 1b selects a specified calling telephone number for indicating the presence of newly-arrived or unopened emails needed to be reported or another specified calling telephone number indicating the number of newly-arrived or unopened emails needed to be reported, generates a response call addressed to the caller telephone number (i.e., caller information) stored in the storage in Step S4 and transmits the call to the user's telephone number through the public telecommunication network 10 (Step S11).

When there is an newly-arrived or unopened email addressed to the user having made the inquiry call, the internet connection device 1 or the server device 1b generates a new call (response call) to the internet facsimile apparatus 2 from which the user transmitted the inquiry call over the public telecommunication network 10 to inform the user of the existence of emails to be reported as newly-arrived emails addressed to the user.

If there was no email newly arrived or unopened in Step S8 (negatively answered at Step S8) or if none of existing emails corresponds to the response condition (negatively answered at Step S10), the interconnect connection device 1 or the server device 1b examines whether the information condition requesting the device to inform the user of the absence of a newly-arrived or unopened email has been set and registered by the user (Step S15).

If the information condition has been set and registered to return a response call informing of the absence of a newly-arrived or unopened email (positively answered at Step S15), the internet connection device 1 or the server device 1b uses a specified calling telephone number different from the specified calling telephone number used for indicating the presence of newly-arrived or unopened emails and dials the connection from the selected telephone line to the user's telephone number stored as the inquiring caller information over the public telecommunication network 10 (Step S16).

Namely, in the case if the information condition registered in advance by the user requires the device to return a response call informing of the absence of emails even in the case there is no newly-arrived or unopened email addressed to the user, the internet connection device 1 or the server device 1b transmits a response call via the public telecommunication network 10 to the internet facsimile apparatus 2 used by the user having transmitted the inquiry call, whereby the user is informed of the absence of newly-arrived or unopened emails to be reported. After this, the process proceeds to Step S12 where the device performs the same actions as in the case of existence of the telephone number to which a response call is sent.

The response call generated in Step S11 or S16 is transmitted through the public telecommunication network 10 to the user's communication terminal, the internet facsimile apparatus 2 that receives the response call and, at the same time, receives by its network control unit 21 and modem 22 the telephone number of the internet connection device 1 or the server device 1b as the caller telephone number (i.e., the caller information) from the local switch LS of the public telecommunication network 10. The caller telephone number of the internet connection device 1 or the server device 1b indicated as caller information is stored in the storage 27 (Step S12).

The internet facsimile apparatus 2 identifies the received call as a response call transmitted from the internet connection device 1 or the server device 1b in response to the inquiry call transmitted from the user's internet facsimile apparatus 2 for inquiring about the presence of newly-arrived or unopened emails therein based on the stored caller information indicating the specified calling telephone number of the internet connection device 1 or the server device 1b.

Namely, the user's internet facsimile apparatus 2 receives the caller telephone number (caller information) provided by the number display service of the public telecommunication number 10 and thereby can recognize the received call as the response call transmitted from the specified number of the internet connection device 1 or the server device 1b in response to the inquiry call transmitted by the user to the internet connection device 1 or the server device 1b.

Furthermore, the user can recognize the existence/absence of newly-arrived or unopened emails addressed to the user or the number of such emails stored in the internet connection device 1 or the server device 1b by knowing the telephone number of the caller transmitting the response call.

Having thus recognized the received call as the response call transmitted from the internet connection device 1 or the server device 1b in response to the inquiry call previously transmitted by the user, the internet facsimile apparatus 2 of the user immediately disconnects the called telephone line without returning an answering signal to the public telecommunication communication network 10 in order not to establish the call (i.e., not to proceed to the chargeable communication phase) (Step S13).

In other words, as soon as the received call was recognized as the response call transmitted from the internet connection device 1 or the server device 1b in response to the inquiry call previously transmitted by the user based on the caller telephone number noticed by the number display service, the internet facsimile apparatus 2 (user's communication terminal) disconnects the call connection without returning an answering signal in order not to proceed to the communication phase chargeable on the calling party.

The line-disconnected signal from the called party is detected by the local switch LS of the public telecommunication network 10 and the calling party (the internet connection device 1 or the server device 1b) is also released by a local switch LS to which the apparatus is connected. Then, the release signal is detected at the internet connection device 1 or the server device 1b, which is also restored into the initial disconnected state (Step S14).

The operation of Steps S7 to S16 at the internet connection device 1 (or the server device 1b) is executed by the operation of the response call generating portion 1a₂ provided in the server 1a of the internet connection device 1 (or the response call generating portion 1b₂ provided in the server device 1b). The operation of Steps S12 to S13 to record the calling number and disconnect the call connection at the user communication terminal (internet facsimile apparatus 2) is executed by the operation of the response call confirming portion 27b (FIG. 2) or the response call confirming portion 37b of the cordless extension terminal set (FIG. 3).

Since this response call thus ends in the call starting phase and does not proceed to the chargeable communication phase, it is a non-chargeable call. Therefore, the response call for informing of the existence of newly-arrived or unopened emails can be completed via the public telecommunication network with no charge.

Both the inquiry call for inquiring about the presence/absence of emails and the response call for informing of the email confirmation result are completed by using the number display service and only the non-chargeable call-starting phase of the public telecommunication network 10. In other words, all call connections between the internet connection device 1 (or server device 1b) through the public telecommunication network 10 can be completed with no charge for communication. Therefore, the user can generate an inquiry call at any desirable intervals or time points predetermined based on the necessary inquiring frequency with no fear of occurring communication charges. Furthermore, it is possible for the user to automatically drive the user's communication terminal to repeat the automatic generation of the inquiry call at any preset periodicity.

In Step S12, the specified telephone number stored in the storage 27, which is indicated by the number display service together with the response call from the internet connection device 1 or the server device 1b, may be specially designated to indicate the presence/absence of newly-arrived or unopened emails to be reported in response to an inquiry call from the user's communication terminal (internet facsimile apparatus 2) or may be different depending on the number of newly-arrived or unopened emails stored therein, including the case there is no email. Therefore, the user can know the presence or absence of newly-arrived or unopened emails or the number of such emails stored therein by the response call telephone number indicated on the user's communication terminal (e.g., the internet facsimile apparatus 2).

Namely, when the response call was completed (disconnected) and the confirmation result (the caller information, i.e., caller telephone number provided by the number display service) was stored in the storage 27 and then, the telephone number stored in the storage 27, that is the caller information, is interpreted into information about the presence/absence of newly-arrived or unopened emails or information concerning the number of existing newly-arrived or unopened emails. The information is then output through the information media designated by the user. The user is now informed of the confirmed information (Step S17).

Information may be output as a voice or audio signal through a handset 21a or a speaker 31a₁ and/or as visual information indicated on a display 28 or 38 and/or as information printed on a printer 25. The informing operation of Step S17 is executed by an email-presence informing portion 27c of the internet facsimile apparatus 2 (FIG. 2) or an email-presence informing portion 37c of the cordless terminal set 3 (FIG. 3).

In Step S15, when the response condition specifies that the response is not required if there is no newly-arrived or unopened email (negatively answered at Step S15), the internet connection device 1 or the server device 1b does not return a response call and ends the operation. In this case, the user-inquirer can know the absence of newly-arrived or unopened emails by the fact that a specified caller's telephone number used for a response call informing of the presence of newly-arrived or unopened emails has not been displayed and stored in a specified area of the storage 27 after a certain lapse of time enough to generate and transmit a response call by the internet connection device 1 or the server device 1b.

Usually, when an ordinary user transmits and receives an electronic mail to and from a remote terminal by doing the dial-up connection through the public telecommunication network, the electronic mail arrived at an internet connection device of the Internet or the at a private network server device of a private network is temporally stored in the internet connection device or a private network server device and then transferred to another internet connection device or another private network server device in which a communication terminal (e.g., a personal computer) of a final addressee is registered as a client thereof. The arrival of the electronic mail to the internet connection device or the server device is inquired and confirmed from the user over the public telecommunication network. However, this conventional arrival-of-email confirming system requires the user to connect the user's communication terminal device to the internet connection device or the server through the public telecommunication network at own expense whenever s/he tries to confirm the arrival of an email at the internet connection device or the server. The communication charge may be wasted if no email is stored in the internet connection device or the server.

On the other hand, there may be an email which content shall be urgently informed of or dealt with, it is necessary for every user to frequently confirm whether there is a newly-arrived or unopened emails in the Internet connection device or the server by connecting own terminal device thereto via the public telecommunication network. The user must expect to pay waste communication charges.

According to the present invention, an inquiry call transmitted from a user's communication terminal such as for example a personal computer and an internet facsimile apparatus to either an internet connection device or a private network server device to inquire about the existence of newly-arrived or unopened emails stored therein and an response call transmitted from the internet device or the server device to the user's communication terminal to confirm the presence of emails can be completed only in non-chargeable call-starting phase without proceeding chargeable communication phase. In such call connections, necessary information can be transmitted and received by using the number display service of the public telecommunication network, thereby the user can be surely informed of the presence/absence of newly-arrived or unopened emails addressed to the user or the number of such emails stored in the internet connection device or the server device.

Therefore, the user can confirm the existence of emails in the internet connection device or the server device by automatically or manually operating the communication terminal at suitable regular intervals or optional time points preset by the user with no fear of occurrence of communication charges of the public telecommunication network. For example, the user's communication terminal can be automatically driven to generate an inquiry call for inquiring about the existence of newly-arrived or unopened emails periodically at regular intervals adaptively predetermined by the user based on the necessary frequency of confirming emails. It is also possible to generate the inquiry call by the communication terminal at a designated time or whenever the user's terminal is switched on or requested by the user to prepare an email.

It is also possible for user to specify that he/she must be informed of the existence of emails by a response call in the case if at least one of existing emails corresponds to the response condition predetermined by the user. Attributes of the newly-arrived or unopened emails to be noticed by the response call may be restricted by specifying, for example, its importance level, the sender's name and a string of characters in the subject. Such emails are also defined by specifying returned or forwarded emails, attached file, transmitted or received period, addressee's name and so on. A versatile inquiring means is thus given to the user.

1. An electronic mail confirming system whereby a user's communication terminal capable of sending/receiving an electronic mail over an Internet or a private network make a call by a dial-up connection to either a special called-only telephone number attached to an internet connection device storing electronic mails transmitted over the Internet or a special called-only telephone number attached to a server device storing electronic mails transmitted over the private network and the internet connection device or the server device receives the call from the user's communication terminal and can recognize said call as an inquiry call for inquiring about the existence/absence therein of newly-arrived or unopened emails addressed to the user.

2. An electronic mail confirming system as defined in claim 1, whereby the internet connection device or the sever device identifies the user having sent the inquiry call for inquiring about the existence/absence of newly-arrived emails therein based on a caller telephone number transmitted thereto by a number display service of a public telecommunication network.

3. An electronic mail confirming system as defined in claim 2, whereby the internet connection device or the sever device having identified the user having sent the inquiry call inquiring about the existence/absence of newly-arrived emails therein based on the caller telephone number transmitted thereto by a number display service of a public telecommunication network immediately disconnects the call without proceeding by returning an answering signal to a chargeable communication phase.

4. An electronic mail confirming system as defined in any one of claims 1 to 3, whereby the internet connection device or the sever device having received the inquiry call for inquiring about the existence of newly-arrived or unopened emails sends a response call indicating the existence of the emails as a response to the inquiry call to the communication terminal of the inquiring user through the public telecommunication network in case of existence of the emails therein and a response call indicating the absence of the emails if such a response call is required to return even in case of absence of the emails.

5. An electronic mail confirming system as defined in claim 4, whereby the user's communication terminal having sent the inquiry call to either the internet connection device or the server device receives a call and a caller telephone number sent by the number display service of the public telecommunication network and recognizes, based on said caller telephone number, the received call as a response call transmitted from either the internet connection device or the server device in response to the inquiry call thereto.

6. An electronic mail confirming system as defined in claim 5, whereby the user's communication terminal having sent the inquiry call and recognized the received call, based on the caller telephone number received from the number display service, as the response call from the internet connection device or the server device in response to the inquiry call sent thereto immediately disconnects the call connection without proceeding by returning answering signal to a chargeable communication phase.

7. An electronic mail confirming system as defined in any one of claims 1 to 3, whereby the internet connection device or the sever device having received the inquiry call for inquiring about the existence of newly-arrived or unopened emails identifies the existence of the emails only in case that any of emails existing therein corresponds to a response condition predetermined by the user.

8. An electronic mail confirming system as defined in claim 7, whereby the response condition predetermined by the user comprises any one or more of terms specifying an importance level, a sender, a character string in a subject, a reply or forwarding emails, transmitted or received period the existence/absence of an attached file or an addressee.

9. An electronic mail confirming system as defined in any one of claims 1 to 3, whereby the internet connection device or the sever device has two kinds of different telephone numbers selectively used for sending the response call responding to the user's inquiry call through the public telecommunication network to the user's communication terminal and uses one for sending the response call in case there is any newly-arrived or unopened email addressed to the user and the other for sending the response call in case there is no email addressed to the user.

10. An electronic mail confirming system as defined in any one of claims 1 to 3, whereby the internet connection device or the sever device has two or more kinds of different telephone numbers selectively used for sending the response call responding to the user's inquiry call through the public telecommunication network to the user's communication terminal and uses different telephone numbers depending on the number of existing newly-arrived or unopened emails including the case of absence of emails addressed the user.

11. An electronic mail confirming system as defined in any one of claims 1 to 3, whereby the user's communication terminal automatically generates and sends the inquiry call for inquiring about the existence of newly-arrived or unopened emails to either the internet connection device or the server device through a public telecommunication network based on an inquiry call starting condition predetermined by the user.

12. An electronic mail confirming system as defined in claim 11, whereby the inquiry call starting condition predetermined by the user comprises one or more terms of periodicity: at regular intervals specified by the user, each at time points designated by the user, each time the user communication terminal is driven into operation, each time the user requests preparation of an email.

13. An electronic mail confirming system as defined in any one of claims 1 to 3, whereby the response call responding to the inquiry call is transmitted to either the user's communication terminal having transmitted the inquiry call or another communication terminal preliminarily designated by the user.

14. An electronic mail confirming system as defined in any one of claims 1 to 3, whereby the user's communication terminal recognizes the response call and informs the user of a result of confirming the response call indicating the existence of newly-arrived or unopened emails by outputting a voice or audio signal through a speaker or handset and/or displaying information on a display unit and/or printing information on a printer.

15. An electronic mail system using the electronic mail confirming system defined in any one of claims 1 to 14.

16. A communication terminal using the electronic mail confirming system defined in any one of claims 1 to 14.

17. An internet connection device using the electronic mail confirming system defined in any one of claims 1 to 14.

18. An electronic mail server device using the electronic mail confirming system defined in any one of claims 1 to 14.
